(19) United States
(12) Patent Application Publication
(10) Pub. No.: US 2017/0107676 A1
(43) Pub. Date: Apr. 20, 2017

(54) SCRAPER BLADE

(71) Applicant: Caterpillar Paving Products Inc., Brooklyn Park, MN (US)

(72) Inventors: Matthew D. Stevens, Elk River, MN (US); Shelley A. Peterson, Becker, MN (US)

(73) Assignee: Caterpillar Paving Products Inc., Brooklyn Park, MN (US)

(21) Appl. No.: 14/883,958

(22) Filed: Oct. 15, 2015

(51) Int. Cl. E01C 19/23; E02D 3/026; B08B 1/00

(52) U.S. Cl. CPC E01C 19/238; B08B 1/005; E02D 3/0265

(57) ABSTRACT

A scraper blade for cleaning a compactor element of a compactor machine is disclosed. The scraper blade includes a body made from an elastomeric matrix material, a fiber reinforcement material embedded in the elastomeric matrix material, and a coating provided on the body. The body includes a top surface, a bottom surface, a leading surface and a trailing surface. The fiber reinforcement material includes fibers extending from the leading surface to the trailing surface. Further, the coating is provided on the body with anti-wear additives.

### TECHNICAL FIELD

The present disclosure relates to a compactor machine, and more particularly to a scraper blade for the compactor machine.

### BACKGROUND

Compactor machines are commonly employed for compacting freshly laid materials, such as earth, asphalt, soil, gravel, and mixtures. The compactor machines may include one or more drum assemblies that further include compacting drums for compacting of the material. In order to improve an efficiency of the compacting, such drum assemblies are often provided with a vibratory mechanism for inducing vibratory forces on the material to be compacted. During the compacting, the compactor drums tend to collect residual material on an outer surface, owing to adhesion between the material and the outer surface of the compacting drum. This would hamper the efficiency of subsequent compacting of the material.

Usually, scraper blades are provided to remove the collected residual material from the outer surface of the compacting drums. Typically, a scraper blade is rigidly attached to a frame of the compactor machine. Sometimes, a biasing member, such as a spring, may also be used to bias the scraper blade against the outer surface of the compacting drum.

### SUMMARY OF THE DISCLOSURE

In one aspect of the present disclosure, a scraper blade for cleaning a compacting element of a compactor machine is provided. The scraper blade includes a body made from elastomeric matrix material including a top surface, a bottom surface, a leading surface and a trailing surface. The scraper blade also includes a fiber reinforcement material embedded in the elastomeric matrix material. The fiber reinforcement material includes fibers extending from the leading surface to the trailing surface. Further, the scraper blade includes a coating provided on the body with anti-wear additives.

In another aspect of the present disclosure, a compacting machine is provided. The compacting machine includes a frame, a compacting element rotatably supported on the frame, and a scraper blade for cleaning the compacting element. The scraper blade includes a body made from an elastomeric matrix material. The body includes a top surface, a bottom surface, a leading surface and a trailing surface. The scraper blade also includes a fiber reinforcement material embedded in the elastomeric matrix material. The fiber reinforcement material includes fibers extending from the leading surface to the trailing surface. Further, the scraper blade includes a coating provided on the body with anti-wear additives.

Other features and aspects of this disclosure will be apparent from the following description and the accompanying drawings.

### BRIEF DESCRIPTION OF THE DRAWINGS

FIG. 1 is a side view of an exemplary compactor machine with a scraper blade, according to an embodiment of the present disclosure; and

FIG. 2 is a partial side view of the compactor machine depicting a cutaway section of the scraper blade, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

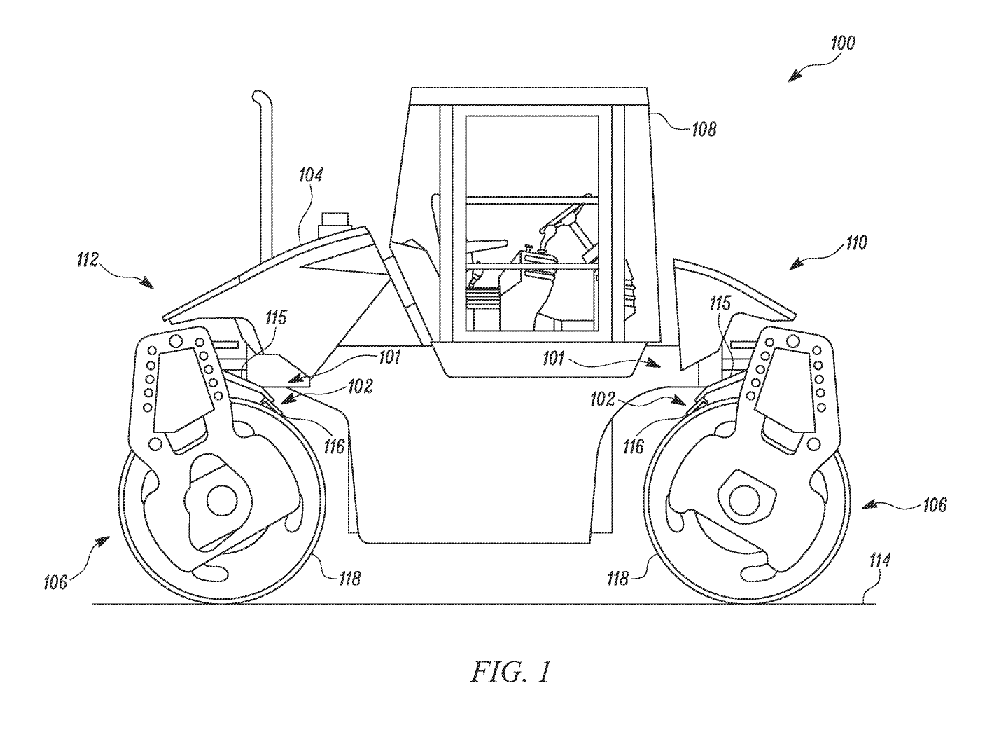

FIG. 1 illustrates a side view of a compactor machine 100 with a scraper blade 102, according to one embodiment of the present disclosure. The compactor machine 100 may include a frame 104, a pair of compacting elements 106 rotatably supported on the frame 104, a scraper blade assembly 101 having the scraper blade 102 for cleaning each of the compacting element 106, and an operator station 108.

In one embodiment, the compactor machine 100 may be one of a landfill compactor, a soil or asphalt compactor, and a vibratory compactor. In the present embodiment, the compactor machine 100 is a self-propelled vehicle. However, the compactor machine 100 may be a tow-behind or a pushed unit to be coupled with another machine, such as, a tractor. Therefore, in various other embodiments, the compactor machine 100 may be any machine that uses a compacting drum for compacting a material on any surface during a compacting process, without departing from the scope of the present disclosure.

In the present embodiment, the pair of the compacting elements 106 is in the form of compacting drums. The pair of the compacting elements 106 may be disposed at a front end 110 and a rear end 112 of the compactor machine 100. The movement of the compacting elements 106 may propel the compactor machine 100 to move over a work surface 114 in a forward or a rearward direction. The work surface 114 may be understood as a surface of the material to be compacted, e.g., concrete being laid down on a road surface.

Although the compactor machine 100 of the present disclosure includes the compacting drums as the compacting elements 106, the compacting machine 100 with other type of compacting elements is also relevant to the present disclosure. For example, the compactor machine 100 may be one of a belted compactor machine and a compactor machine with a single rotating compacting drum. Further, the compactor machine 100 may also include a vibratory apparatus (not shown) associated with one or both of the compacting elements 106.

For cleaning each of the compacting element 106, the scraper blade assembly 101 may be coupled to the frame 104. The scraper blade assembly 101 may include the scraper blade 102 and a support member 115 for supporting the scraper blade 102 on the frame 104. The scraper blade assembly 101 may be coupled to the frame 104 such that a cleaning edge 116 of the scraper blade 102 may be pressed against an outer surface 118 of the compacting element 106. The outer surface 118 of the compacting element 106 is the surface that comes in contact with the work surface 114. The support member 115 may assist the scraper blade 102 to maintain a close contact with the outer surface 118 for removal of the residual material. In one embodiment, the scraper blade assembly 101 may include a spring member (not shown) for maintaining an appropriate force on the scraper blade 102 to stay in contact with the outer surface 118.

Further, the operator station 108 may accommodate an operator to control operations of the compactor machine 100. The operator station 108 may include a number of control equipment (not shown) for the operator to control the operations of the compactor machine 100. The number of control equipment may include, but is not limited to, a steering wheel, control levers, display devices for displaying information to the operator, and an electronic system for allowing the operator to electronically control various systems/components of the compactor machine 100, such as an engine (not shown).

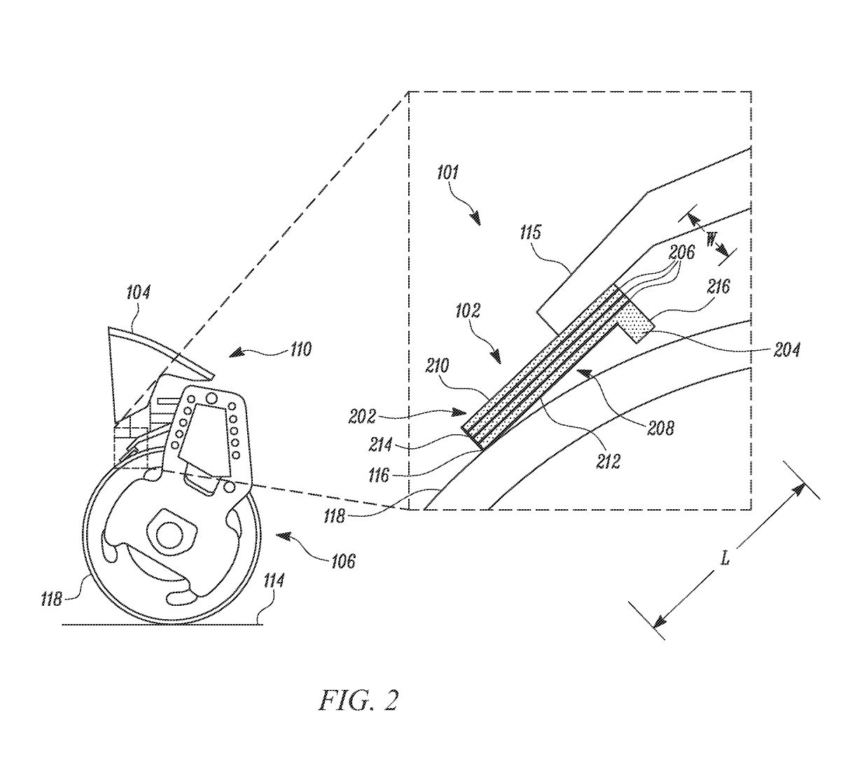

FIG. 2 illustrates a partial side view of the compactor machine 100 depicting a cutaway section of the scraper blade 102, according to an embodiment of the present disclosure. The scraper blade 102 is used for removing the residual material from each of the compacting element 106. The scraper blade 102 may include a body 202 made from an elastomeric matrix material 204, a fiber reinforcement material 206 embedded in the elastomeric matrix material 204, and a coating 208 provided on the body 202.

The body 202 may include a top surface 210, a bottom surface 212, a leading surface 214, and a trailing surface 216. The top surface 210 and the bottom surface 212 may face the frame 104 and the compacting element 106 of the compactor machine 100, respectively. Further, the leading surface 214 may be understood as the surface of the body 202 that comes in contact with the compacting element 106 for removing the residual material. On the other hand, the trailing surface 216 may be understood as the surface following the leading surface 214 of the body 202 while removing the residual material. The leading surface 214 and the trailing surface 216 define a length L of the scraper blade 102. The bottom surface 212 and the leading surface 214 form the cleaning edge 116 of the scraper blade 102 to maintain the close contact with the outer surface 118 of the compacting element 106. The cleaning edge 116 may remove the residual material from the outer surface 118.

In one embodiment, the elastomeric matrix material 204 may be a resin material. Such resin material may include, but is not limited to, urethane resins including caprolactones, polyesters and polyethers, polysiloxane rubber, polytetrafluorethylene resin, polytrifluorchloroethylene resin, styrenebutadiene rubber, nitrile rubber, nitrosilicone rubber, polyethylene rubber and blends and mixtures and copolymers thereof

In an embodiment, the fiber reinforcement material 206 is embedded in the elastomeric matrix material 204. The fiber reinforcement material 206 may be embedded in form of fiber layers disposed across a width W of the scraper blade 102. The fiber layers of the fiber reinforcement material 206 may extend from the leading surface 214 to the trailing surface 216. In one embodiment, the fiber layers of the fiber reinforcement material 206 may be disposed parallel to the top surface 210 and the bottom surface 212 of the body 202. In one embodiment, the length of fiber layers to be disposed in the elastomeric matrix material 204 may depend on operational parameters, such as a type of the fiber reinforcement material 206, a process of forming the scraper blade 102, and a desired reinforcement effect. Similarly, the density of the fiber layers or a volume of the fiber reinforcement material 206 in the elastomeric matrix material 204 may vary accordingly.

In one embodiment, the fiber reinforcement material 206 may include nylon fiber. In another embodiment, the fiber reinforcement material 206 may include glass fiber. In yet another embodiment, the fiber reinforcement material 206 may include carbon fiber. In one example, the fiber reinforcement material 206 may include, but is not limited to, graphite, mineral, polyesters, polyurethane terephthalate, boron, silicon carbide, aramid, ceramic and metal fibers. The fiber reinforcement material 206 may be selected based on Young's modulus, compatibility with the fiber reinforcement material 206, a desired service life, and an application of the scraper blade 102. A variety of techniques may be used for disposing the fiber reinforcement material 206 in the elastomeric matrix material 204. In one embodiment, some additives may be used for ensuring a good bonding between the elastomeric matrix material 204 and the fiber reinforcement material 206.

Further, the coating 208 may be provided on the body 202 of the scraper blade 102 with anti-wear additives for imparting anti-wear properties to the scraper blade 102. In one embodiment, the coating 208 may be of metal carbide, e.g., tungsten carbide.

### INDUSTRIAL APPLICABILITY

The present disclosure relates to the compactor machine 100 with the scraper blade 102 for cleaning the compacting elements 106, in accordance with an embodiment of the present disclosure. The scraper blade 102 may include the body 202 made of the elastomeric matrix material 204, the fiber reinforcement material 206 embedded in the elastomeric matrix material 204, and the coating 208 provided on the body 202 for anti-wear properties. The scraper blade 102 may be employed in any machine that demands removal of residual material from a component, during the compacting process. In the present disclosure, the scraper blade 102 is being used for removing the residual material from the compacting element 106 of the compactor machine 100.

The scraper blade 102 of the present disclosure has a simple construction, which would assist in an easy installation and uninstallation of the scraper blade 102 on and from the compactor machine 100, respectively. The scraper blade 102 may be conveniently connected to the frame 104 by using standard attachment techniques, such as fastening, and adhesives. Therefore, replacement of the scraper blade 102, as and when required, does not demand significant efforts. Further, owing to the simple construction, the maintenance concerns related to the scraper blade 102 are minimal. Also, the combination of the elastomeric matrix material 204, the fiber reinforcement material 206, and the coating 208 allows an effective removal of the residual material from the compacting elements 106. The abovementioned composition enhances the service life of the scraper blade 102 as well. Further, the scraper blade 102 can be made apt for a wide variety of applications by making small changes in the composition of the scraper blade 102. Moreover, cost associated with the manufacturing and operation of the scraper blade 102 is significantly low as compared to traditional metal blades or plastic blades. In addition, the operation of the scraper blade 102 of the present disclosure is significantly less noisy as compared to the scraper blades 102 made of metal or steel. Therefore, the present disclosure offers a simple scraper blade 102 that is effective, quiet, economic, convenient to maintain, and easy to manufacture.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A scraper blade for cleaning a compacting element of a compactor machine, the scraper blade comprises:
a body made from elastomeric matrix material including a top surface, a bottom surface, a leading surface and a trailing surface;
a fiber reinforcement material embedded in the elastomeric matrix material, wherein the fiber reinforcement material having fibers extending from the leading surface to the trailing surface; and
a coating provided on the body with anti-wear additives.

2. The scraper blade of claim 1, wherein the elastomeric matrix material is resin material.

3. The scraper blade of claim 1, wherein the fibers are oriented parallel to the top surface and the bottom surface in the elastomeric matrix material.

4. The scraper blade of claim 1, wherein the fiber reinforcement material is nylon fiber.

5. The scraper blade of claim 1, wherein the fiber reinforcement material is glass fiber.

6. The scraper blade of claim 1, wherein the fiber reinforcement material is carbon fiber.

7. The scraper blade of claim 1, wherein the anti-wear additive includes metal carbides.

8. A compactor machine comprising:
a frame;
a compactor element rotatably supported on the frame; and
a scraper blade for cleaning the compactor element, the scraper blade includes:
a body made from elastomeric matrix material including a top surface, a bottom surface, a leading surface and a trailing surface;
a fiber reinforcement material embedded in the elastomeric matrix material, wherein the fiber reinforcement material having fibers extending from the leading surface to the trailing surface; and
a coating provided on the body with anti-wear additives.

9. The compactor machine of claim 8, wherein the elastomeric matrix material is resin material.

10. The compactor machine of claim 8, wherein the fibers are oriented parallel to the top surface and the bottom surface in the elastomeric matrix material.

11. The compactor machine of claim 8, wherein the fiber reinforcement material is nylon fiber.

12. The compactor machine of claim 8, wherein the fiber reinforcement material is glass fiber.

13. The compactor machine of claim 8, wherein the fiber reinforcement material is carbon fiber.

14. The compactor machine of claim 8, wherein the anti-wear additive includes metal carbides.

15. A scraper blade assembly for cleaning a compacting element of a compactor machine, the scraper blade assembly comprises:
a support member coupled to a frame of the compactor machine; and
a scraper blade, coupled to the support member, for cleaning the compactor element, the scraper blade includes:
a body made from elastomeric matrix material including a top surface, a bottom surface, a leading surface and a trailing surface;
a fiber reinforcement material embedded in the elastomeric matrix material, wherein the fiber reinforcement material having fibers extending from the leading surface to the trailing surface; and
a coating provided on the body with anti-wear additives.

16. The scraper blade assembly of claim 15, wherein the elastomeric matrix material is resin material.

17. The scraper blade assembly of claim 15, wherein the fibers are oriented parallel to the top surface and the bottom surface in the elastomeric matrix material.

18. The scraper blade assembly of claim 15, wherein the fiber reinforcement material is nylon fiber.

19. The scraper blade assembly of claim 15, wherein the fiber reinforcement material is glass fiber.

20. The scraper blade assembly of claim 15, wherein the anti-wear additive includes metal carbides.
